(19) United States
(12) Patent Application Publication
(10) Pub. No.: US 2016/0378357 A1
(43) Pub. Date: Dec. 29, 2016

(54) HYBRID STORAGE DEVICE AND METHOD FOR OPERATING THE SAME

(71) Applicant: KABUSHIKI KAISHA TOSHIBA, Tokyo (JP)

(72) Inventors: Masatoshi AOKI, Yokohama Kanagawa (JP); Fumitoshi HIDAKA, Yokohama Kanagawa (JP); Itaru KAKIKI, Yokohama Kanagawa (JP); Kaori NAKAO, Ota Tokyo (JP)

(21) Appl. No.: 15/189,949

(22) Filed: Jun. 22, 2016

(30) Foreign Application Priority Data
Jun. 24, 2015 (JP) 2015-126403

(51) Int. Cl. G06F 3/06; G11B 20/12; G06F 12/0866

(52) U.S. Cl. CPC G06F 3/0611; G06F 12/0866; G06F 3/0658; G06F 3/068; G11B 20/1217; G06F 2212/1024; G06F 2212/217; G06F 2212/222; G06F 2212/281; G11B 2020/1238; G11B 2020/1292

(57) ABSTRACT

A storage device includes a disk medium having a first recording region and a second recording region, a non-volatile semiconductor memory, and a controller. The controller is configured to write data of a first type into tracks of the first recording region that partially overlap with each other, to write for caching data of a second type into tracks of the second recording region, and to write for caching the data of the second type stored in the disk medium into the non-volatile semiconductor memory.

### CROSS-REFERENCE TO RELATED APPLICATION

This application is based upon and claims the benefit of priority from prior Japanese Patent Application No. 2015-126403, filed Jun. 24, 2015, the entire contents of which are incorporated herein by reference.

### FIELD

Embodiments described herein generally relate to a storage device, in particular, a hybrid storage device including a disk medium and a semiconductor memory unit.

### BACKGROUND

In recent years, a hybrid type disk drive which has a nonvolatile memory, e.g. an NAND type flash memory, as a data storage media, in addition to a disk, has been developed in a field of disk drives represented by a hard disk drive (HDD).

Further, a disk drive of one type uses a disk including a shingled write recording area (hereinafter, shingled recording area or SMR [Shingled Magnetic Recording] area) having higher track density (Track Per Inch; TPI) and a media cache area used as cache for data to be written in the shingled recording area.

That is, in such a disk drive, write data sent from a host is stored in one of the shingled recording area on the disk, the media cache area on the disk, and the NAND type flash memory.

### BRIEF DESCRIPTION OF THE DRAWINGS

FIG. 1 is a block diagram of a disk drive according to an embodiment.

FIG. 2 schematically illustrates tracks of the disk drive in accordance with an SMR operation.

FIG. 3 illustrates characteristics of each recording area.

FIG. 4 illustrates a table indicative of an order of capacity of each area in (a) and a table indicative of an order of read/write performance of each area in (b).

FIG. 5 is a flowchart of a data write operation according to an embodiment.

FIG. 6 is a flowchart of a data read operation according to an embodiment.

### DETAILED DESCRIPTION

In general, according to an embodiment, a storage device includes a disk medium having a first recording region and second recording region, a non-volatile semiconductor memory, and a controller. The controller is configured to write data of a first type into tracks of the first recording region that partially overlap with each other, to write for caching data of a second type into tracks of the second recording region, and to write for caching the data of the second type stored in the disk medium into the non-volatile semiconductor memory.

Embodiments will be described hereinafter with reference to the accompanying drawings.

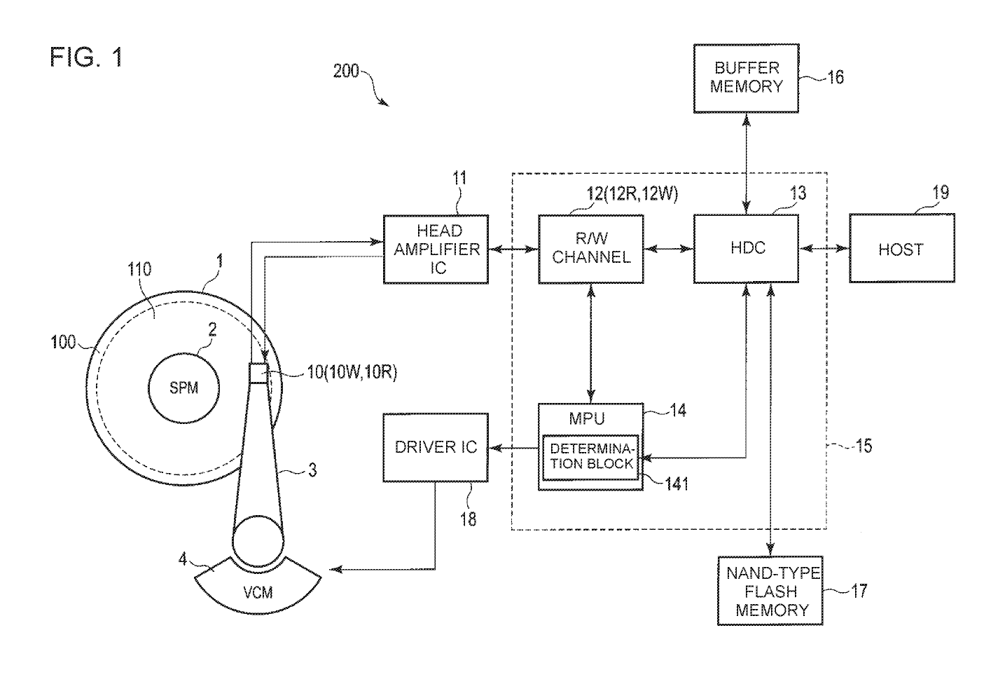

FIG. 1 is a block diagram of a disk drive 200 according to an embodiment.

As illustrated in FIG. 1, the disk drive (disk storage apparatus) 200 of the present embodiment is a hybrid-type disk drive and includes a magnetic disk medium (hereinafter, a disk) 1, as a storage media, and a NAND type flash memory (an example of nonvolatile memory) 17. The disk drive 200 further includes a head disk assembly (HDA) which will be explained below, a head amplifier integrated circuit (hereinafter head amplifier IC) 11, a system controller (controller) 15 composed of, in one example, a single-chip integrated circuit, a buffer memory (DRAM) 16, and a driver IC 18.

The HDA includes, in addition to the disk 1, a spindle motor (SPM) 2, an arm 3 mounting a head 10, and a voice coil motor (VCM) 4. The disk 1 is rotated by the SPM 2. The arm 3 and the VCM 4 serve as an actuator. The actuator is driven by the VCM 4 to control movement of the head 10 mounted on the arm 3 to a specified position on the disk 1.

The head 10 includes a slider as a main body, and includes a write head 10W and a read head 10R mounted in the slider. The read head 10R reads data written in tracks on the disk 1. The write head 10W writes the data to the disk 1.

The head amplifier IC 11 includes a read amplifier and a write driver. The read amplifier amplifies a read signal which is read by the read head 10R, and transmits the amplified signal to a read/write (R/W) channel 12 of the controller 15. The write driver transmits a write current corresponding to write data output from the R/W channel 12 to the write head 10W. The driver IC 18 controls driving of the SPM 2 and the VCM 4.

The controller 15 includes the R/W channel 12, a hard disk controller (HDC) 13, and a microprocessor (MPU or processor) 14. The R/W channel 12 includes a read channel 12R that executes signal processing of the read data and a write channel 12W that executes signal processing of the write data.

The HDC 13 controls data transfer, according to MPU 14, between a host 19 and the R/W channel 12. The HDC 13 controls the buffer memory 16 and executes data transmission control to temporarily store data read from the disk 1 (read data) and data to be written to the disk 1 (write data).

The NAND-type flash memory (hereinafter NAND memory) 17 is a semiconductor memory where the stored data are held even if power supply is cut off.

The NAND memory 17 has a threshold value of a number of writing thereto. In the present embodiment, the NAND memory 17 stores (caches) data (read data) read from the disk 1, for example, corresponding to a read request from the host 19.

The MPU 14 is a main controller which controls each unit of the disk drive 200, and includes a determination block 141. The MPU 14 controls VCM 4 via the driver IC 18 and performs servo control to position the head 10. Further, the MPU 14 further controls data write operations with respect to the disk 1 and operations to select write destination of write data transferred from the host 19, as described below. Here, the data write operation controlled by the MPU 14 includes a SMR [Shingled write Magnetic Recording] operation.

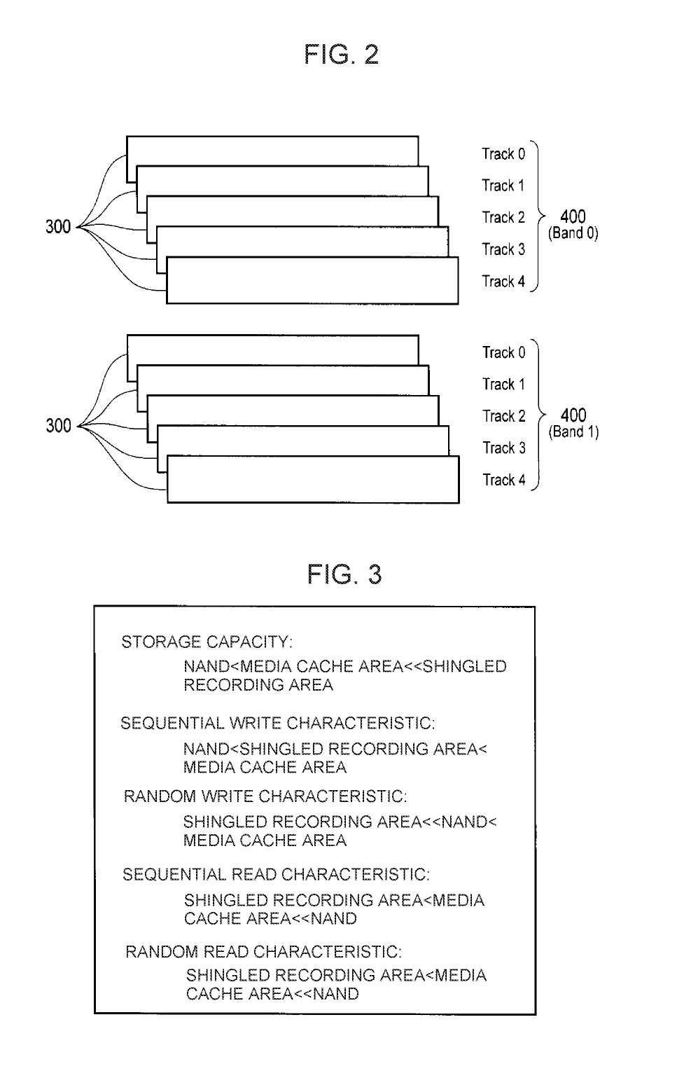

FIG. 2 schematically illustrates tracks of the disk 1 in accordance with the SMR operation performed in the disk drive 200 according to the embodiment.

In the disk drive 200, data are written to the disk 1 by the write head 10W, and tracks are formed in a circumference direction of the disk 1. As illustrated in FIG. 2, each track 300 is sequentially written with partially overlapping each other in the SMR operation. A data writing area (or a data capacity unit thereof) including groups of such tracks, for example groups of 5 tracks respectively, is called “band” (band 0, 1) 400.

A guard track (guard area) is formed to prevent data interference between adjacent bands 400. In each band 400, data are written by the write head 10W from track numbers 0, 1, 2, 3, and 4 in order (Track 0, 1, 2, 3, and 4), as shown in FIG. 2. In tracks 300 of the track numbers 0-3, width of each track is thinner at one side because data written in the next track interferes with the data written in the track. However, in a track 300 of the track numbers 4, data interference is unlikely to occur because data are not written to the guard track.

By using such an SMR operation of sequentially writing with partially overlapped tracks, a gap between tracks can be designed to be narrower and it is possible to increase density of tracks formed on the disk 1.

Referring to FIG. 1 again, the SMR area (hereinafter shingled recording area) 110 is main data writing area of the disk 1 and is area in which data are written, in accordance with the SMR operation, to each track so as to partially overlap with the adjacent track. That is, the shingled recording area 110 includes a track and a track which partially overlaps with the track. A media cache area 100 is data writing area formed at outer side of the disk 1 and serves as a cache of the shingled recording area 110.

It is desirable that data are written to the media cache area 100 in accordance with a normal writing operation and that the media cache area 100 has lower track density than that of the shingled recording area 110. To the media cache area 100, write data transferred from the host 19 are sequentially written. The media cache area 100 has capacity sufficiently larger than that of one band. The MPU 14 at a specific timing, transfers data which are temporally stored in the media cache area 100 to the shingled recording area 110, more detail to a band that is user data area. This can prevent for performance to be degraded, because the media cache area 100 is prevented from becoming full.

The determination block 141 determines writing area to which data are to be written and outputs determination result to the MPU 14. The determination block 141 determines (selects) writing area as write destination of write data, based on characteristics of a plurality of writing areas. For example, the determination block 141 includes a table indicative of the characteristics of the writing areas and determines writing area to which data are to be written according to the table. The determination block 141 controls each block via the MPU 14 to determine the writing areas. Here, the determination block 141 may be included in the MPU 14 as firmware.

The determination block 141 determines, in response to receiving a write command from the host 19, whether write data from the host 19 are sequential data or random data based on the size of the write data, where logical block address (LBA) of the sequential data is continuous and that of the random data is discontinuous. The determination block 141 selects either the media cache area 100 or the shingled recording area 110 as the write destination of the write data, based on the determination result. The determination block 141 may determine the sequential data to be written preferentially to the shingled recording area 110. It should be noted that the sequential data may have data size larger than that of the random data, and is deemed to be sequential because the LBA of the data is sequential.

The determination block 141 determines, if data (read data) to be read in response to a read command from the host 19 are stored on the disk (the media cache area 100 or the shingled recording area 110) 1, whether the read data are likely to be read at a next reading, and is a small block. The determination block 141 copies the read data to the NAND memory 17 as read cache, if it is determined that the read data are likely to be read at the next reading, and is a small block. As a result, the cached data can be read from the NAND memory 17 at the next reading.

Characteristics of writing areas (recording areas), such as the NAND memory 17, the media cache area 100, and the shingled recording area 110, formed in the disk drive 200 and a table indicative of the characteristics will be described with reference to the accompanying drawings, hereinafter.

FIG. 3 illustrates characteristic of each recording area. As shown in FIG. 3, “sequential write” indicates operation of continuously writing (re-writing) data (the sequential data) having sequential LBA, and “sequential read” indicates operation of reading the sequential data. “Random write” indicates operation of discontinuously writing (re-writing) data (the random data) having discontinuous LBA, and “random read” indicates operation of reading the random data. “Writing characteristic” indicates data transfer rate (processing speed of data) in writing, and “reading characteristic” indicates data transfer rate (processing speed of data) in reading. As shown in FIG. 3, storage capacity of the shingled recording area 110 is considerably large, and those of the media cache area 100 and the NAND memory 17 are smaller in order.

The sequential write characteristics are high in the order of the media cache area 100, the shingled recording area 110, and the NAND memory 17. The random write characteristics are high in the order of the media cache area 100, the NAND memory 17, and the shingled recording area 110.

The sequential read characteristics are high in the order of the NAND memory 17, the media cache area 100, and the shingled recording area 110. The random read characteristic of the NAND memory 17 is considerably large, and those of the media cache area 100 and the shingled recording area 110 are smaller in that order.

It is desirable that the sequential data are to be written in the shingled recording area 110 of the disk 1. In addition, it is expected that performance (efficiency) increases once random data that are read are temporally stored (cached) in the NAND memory 17.

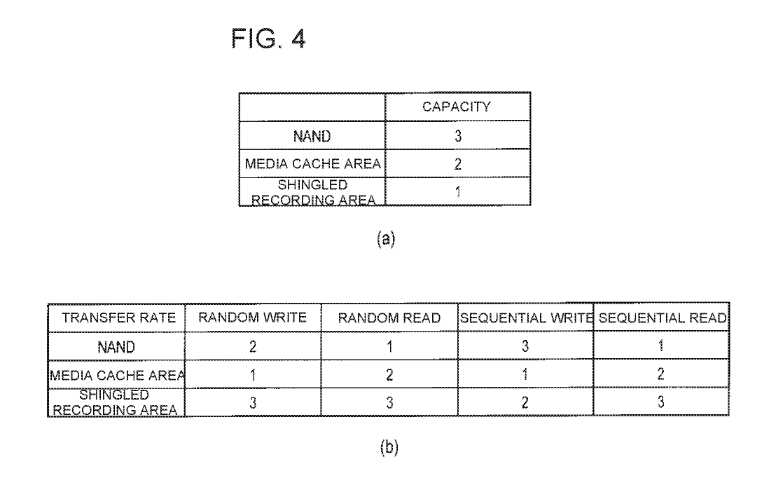

FIG. 4(a) illustrates a table indicative of an order of capacity of each recording area. FIG. 4(b) illustrates a table indicative of an order of read/write performance of each recording area. In FIG. 4, numbers of both tables indicate high performance in ascending order. That is, the number “1” indicates the highest performance among three writing areas (the NAND memory 17, the media cache area 100, and the shingled recording area 110), and the number “3” indicates lower performance than performances of writing areas indicated by the number “1” and “2”. The determination block 141, in the case of receiving the write command from the host 19, determines priority of writing areas, in ascending order of each number based on the tables shown in FIGS. 4A and 4B. However, the priority of the writing areas is not always determined in the ascending order. For example, the determination block 141 may determine the data are to be written to another writing area, if capacity of the writing area with higher priority is insufficient. In the following, a case of not storing data to each writing area includes a case that vacant capacity is insufficient.

[Data Write Operation]

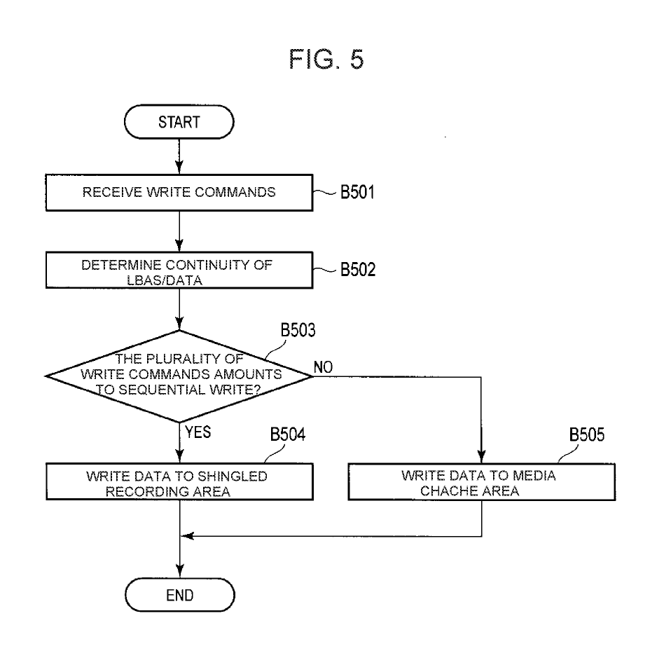

A data write operation according to an embodiment will be described with reference to FIG. 5. FIG. 5 is a flowchart of a data write operation according to the embodiment. First, as shown in FIG. 5, the HDC 13 receives a command (here, write command) sent from the host 19 via an interface, which includes LBA (B501). The HDC 13 stores write data sent subsequently to the command, to the buffer memory 16. In that time, the HDC 13 may receive a plurality of write commands (and a plurality of write data).

The determination block 141 (MPU 14) determines a continuity of received LBAs and write data based on LBAs included in the received plurality of write commands (B502). The determination block 141 determines whether the received write data are the sequential data or the random data based on the determination result of the continuity (B503). That is, the determination block 141 determines whether a write operation requested by the write command is a sequential write operation to write the sequential data or a random write operation to write the random data.

When the write operation according to the plurality of write commands is determined to be the sequential write operation (B503 Yes), the MPU 14 writes the sequential data to the shingled recording area 110 (B504) and ends the write operation.

On the other hand, when the write operation according to the plurality of write commands is not determined to be the sequential write, that is the random write (B503 No), the MPU 14 writes the random data to the media cache area 100 (B505) and ends the write operation. The data written (cached) in the media cache area 100 are moved from and rewritten to the shingled recording area 110 at a specific timing. That is, in the present embodiment, the MPU 14 does not write the write data to the NAND memory 17 in response to the write command from the host 19.

[Data Read Operation]

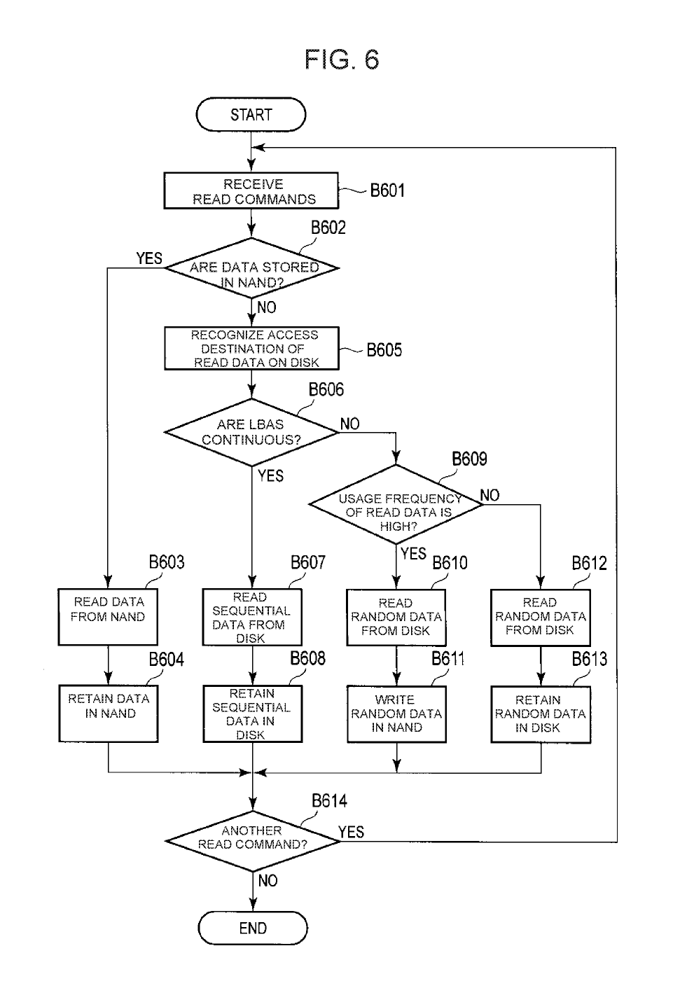

An exemplary data read operation according to an embodiment will be described with reference to FIG. 6. FIG. 6 is a flowchart of a data read operation according to the embodiment. First, as shown in FIG. 6, the HDC 13 receives a command (herein, read command; read request) sent from the host 19 via the interface (B601). Then, the MPU 14 specifies LBA of the read command. The MPU 14 determines whether or not data to be read are stored (cached) in the NAND memory 17 based on the read command from the host 19 (B602).

When the data are determined to be stored in the NAND memory 17 (B602 Yes), the HDC 13 reads the data stored in the NAND memory 17, and sends read data to the host 19 (B603). The HDC 13 retains the read data in the NAND memory 17 (B604).

Returning to the processing in B602, when the data to be read are not determined to be stored in the NAND memory 17 (B602 No), the HDC 13 recognizes an access destination of the read data in the writing area of the disk 1 (the media cache area 100 and the shingled recording area 110) based on the priority in the table (referring to FIG. 3) indicative of the characteristics of the writing areas (B605).

The MPU 14 determines whether or not LBAs of the read data are continuous (B606). That is, the MPU 14 determines the read data are the sequential data or the random data.

When the read data are determined to be the sequential data (B606 Yes), the HDC 13 reads the sequential data from a sector of the disk 1 corresponding to the LBAs and sends the read sequential data to the host 19 (B607). For example, the sequential data are written in the shingled recording area 110 of the disk 1, the HDC 13 reads out the sequential data from the shingled recording area 110 and sends the readout sequential data to the host 19. The MPU 14 retains the read data (here, the sequential data) in the writing area of the disk 1 (B608). The MPU 14 decides to retain the read data in the shingled recording area 110 that have large capacity, in accordance with the priority in the table (referring to FIG. 3) indicative of the characteristics of the writing areas.

Returning to the processing in B606, when the read data are not determined to be the sequential data (B606 No), the MPU 14 determines whether a usage frequency of data to be read is higher than that of other data (B609). At that time, the MPU 14 comprises a list (not shown) including usage frequencies of data of each sector and a threshold value regarding usage frequency. The MPU 14 determines that the usage frequency of the data to be read is equal or more than the threshold value, referring the list.

When the usage frequency of the data to be read is determined to be higher than that of other data (B609 Yes), the HDC 13 reads the random data from a sector of the disk 1 corresponding to the LBAs and sends the read random data to the host 19 (B610). At that time, when the random data are written in the media cache area 100 of the disk 1, the HDC 13 reads the random data from the media cache area 100 and sends the read random data to the host 19. The MPU 14 determines from the usage frequency that there is a high possibility that the read data (here, the random data) will be requested to be read again because of high usage frequency. The HDC 13 write (caches), in accordance with the determination, the random data that are highly likely to be requested to be read again to the NAND memory 17, because NAND memory 17 has high random read characteristics (B611).

Returning to the processing in B609, when the usage frequency of the data to be read is not determined to be higher than that of other data (B609 No), the HDC 13 reads the random data from a sector of the disk 1 corresponding to the LBAs, and sends the read random data to the host 19 (B612). At that time, if the random data are written in the media cache area 100 of the disk 1, the HDC 13 reads the random data from the media cache area 100 and sends the read random data to the host 19.

The MPU 14 determines that there is a low possibility that the read data (herein, the random data) will be requested to be read again because of low usage frequency. The HDC 13 retains, in accordance with the determination, the read random data in a recording area of the disk 1 (B613). The MPU 14 retains the read random data in the media cache area 100 having higher random read characteristics than that of the shingled recording area 110, in accordance with the priority in the table indicative of the characteristics of the writing areas.

The MPU 14 determines whether another read command from the host 19 is present (B614). When it is determined that another read command is present (B614 Yes), the MPU 14 returns to the processing of B601. When it is not determined that another read command is present (B614 No), the MPU 14 ends the read operations.

According to the present embodiment, the disk drive 200 is a hybrid-type disk drive and includes, as writing areas, the disk 1 adapting the shingled writing scheme and the NAND memory 17. The disk drive 200 can select a writing area in which data are to be written, in accordance with characteristic of each writing area. Thus, the disk drive 200 writes the sequential data having continuous LBA to the shingled recording area 110 of larger capacity, and can restrict writing data to the NAND memory 17 or the media cache area 100, both having limited capacity.

Further, the disk drive 200 retains random data having high usage frequency and being small blocks in the NAND memory 17 having high transfer speed, when data are read in response to a read request from the host 19. The disk drive 200 preferentially writes data being continuous LBAs (the sequential data) to the shingled recording area 110 having large capacity without writing the data to the NAND memory 17, when data are written in response to a write request from the host 19. Therefore, it is possible to suppress degradation of the NAND memory 17. As a result, performance of the disk drive 200 may be maintained for a longer period of time.

While a certain embodiment has been described, the embodiment has been presented by way of example only, and is not intended to limit the scope of the invention. Indeed, the novel embodiment described herein may be brought into practice in a variety of other forms; furthermore, various omissions, substitutions and changes may be made in the embodiment described herein without departing from the spirit of the invention. The accompanying claims and their equivalents are intended to cover such forms or modifications as would fall within the scope and spirit of the invention.

What is claimed is:

1. A storage device, comprising:
a disk medium having a first recording region and a second recording region;
a non-volatile semiconductor memory; and
a controller configured to write data of a first type into tracks of the first recording region that partially overlap with each other, to write for caching data of a second type into tracks of the second recording region, and to write for caching the data of the second type stored in the disk medium into the non-volatile semiconductor memory.

2. The storage device according to claim 1, wherein
the controller is further configured to, at a predetermined timing, write the data of the second type cached in the second recording region into tracks of the first recording region that partially overlap with each other.

3. The storage device according to claim 1, wherein
the controller is configured to determine whether or not to write for caching the data of the second type stored in the disk medium into the non-volatile semiconductor memory, based on a read frequency thereof.

4. The storage device according to claim 1, wherein
the data of the first type are sequential data, and the data of the second type are random data.

5. The storage device according to claim 1, wherein
the controller writes for caching the data of the second type stored in the disk medium into the non-volatile semiconductor memory, in response to a read request thereof.

6. The storage device according to claim 1, wherein
the controller reads the data of the second type from the non-volatile semiconductor memory, when said data are cached in the non-volatile semiconductor memory, and from the disk medium, when said data are not cached in the non-volatile semiconductor memory.

7. The storage device according to claim 6, wherein
a data transfer rate of reading from the second recording region is lower than a data transfer rate of reading from the non-volatile semiconductor memory.

8. The storage device according to claim 1, wherein
a data transfer rate of writing into the second recording region is greater than a data transfer rate of writing into the non-volatile semiconductor memory.

9. The storage device according to claim 1, wherein
a data transfer rate of reading from the second recording region and a data transfer rate of writing sequential data into the second recording region are respectively higher than a data transfer rate of reading from the first recording region and a data transfer rate of writing sequential data into the first recording region.

10. A method for operating a storage device including a disk medium having a first recording region and a second recording region, and a non-volatile semiconductor memory, the method comprising:
when data are of a first type, writing the data into tracks of the first recording region that partially overlap with each other; and
when data are of a second type, writing for caching the data into tracks of the second recording region, and writing for caching the data of the second type stored in the disk medium into the non-volatile semiconductor memory.

11. The method according to claim 10, further comprising:
at a predetermined timing, writing the data of the second type cached in the second recording region into tracks of the first recording region that partially overlap with each other.

12. The method according to claim 10, further comprising:
determining to carry out the caching of the data of the second type stored in the disk medium into the non-volatile semiconductor memory, based on a read frequency thereof, wherein
said caching of the data of the second type stored in the disk medium is carried out in response to the determination.

13. The method according to claim 10, wherein
the data of the first type are sequential data, and the data of the second type are random data.

14. The method according to claim 10, further comprising:
reading the data of the second type from the non-volatile semiconductor memory, when said data is cached in the non-volatile semiconductor memory, and from the disk medium, when said data is not cached in the non-volatile semiconductor memory.

15. The method according to claim 14, wherein
a data transfer rate of reading from the second recording region is lower than a data transfer rate of reading from the non-volatile semiconductor memory.

16. The method according to claim 10, wherein
a data transfer rate of writing into the second recording region is greater than a data transfer rate of writing into the non-volatile semiconductor memory.

17. A storage device, comprising:
a disk medium;
a non-volatile semiconductor memory; and
a controller configured to write data of a first type and data of a second type into the disk medium without caching the data into the non-volatile semiconductor memory in response to write requests, read the data of the first type from the disk medium in response to a first read request without caching into the non-volatile semiconductor memory, and read the data of the second type from the disk medium in response to a second read request along with caching into the non-volatile semiconductor memory.

18. The storage device according to claim 17, wherein
the controller is further configured to read the data of the second type and that is cached data from the non-volatile semiconductor memory in response to the second read request.

19. The storage device according to claim 17, wherein
the controller is configured to determine whether or not to cache the data of the second type into the non-volatile semiconductor memory, based on a read frequency thereof.

20. The storage device according to claim 17, wherein
the data of the first type are sequential data, and the data of the second type are random data.
